(19) United States
(12) Patent Application Publication
(10) Pub. No.: US 2006/0092814 A1
(43) Pub. Date: May 4, 2006

(54) Aberration compensation element, and optical system and optical device provided with the same

(75) Inventors: Ho Seop Jeong, Kyunggi (KR); Soo Jin Jung, Kyunggi-do (KR); Chon Su Kyong, Seoul (KR)

Correspondence Address: DARBY & DARBY P.C., P. O. BOX 5257, NEW YORK, NY, 10150-5257, US

(73) Assignee: Samsung Electro-Mechanics Co., Ltd., Kyunggi-do (KR)

(21) Appl. No.: 11/266,860

(22) Filed: Nov. 3, 2005

(30) Foreign Application Priority Data
Nov. 4, 2004 (KR) 10-2004-0089370

(51) Int. Cl. G11B 7/00

(52) U.S. Cl. 369/112.02; 369/112.01

(57) ABSTRACT

The optical system of the present invention comprises a three-wavelength hologram module in which a three-wavelength light emitter/photodetector and a hologram are integrated, a collimate lens, an aberration compensation element, an aperture selector, and an objective lens. The aberration compensation element has glass substrates and a liquid crystalline layer interposed between the glass substrate, the liquid crystalline layer having a curved face of a predetermined curvature. Also, the aberration compensation element has a diffraction pattern formed on one side thereof. With the structure, the aberration compensation element can compensate spherical and chromatic aberrations in the light beams passing therethrough, at the same time.

### INCORPORATION BY REFERENCE

The present application claims priority under 35 U.S.C. §119 to Korean Patent Application No. 10-2004-0089370 filed on Nov. 4, 2004. The content of the application is incorporated herein by reference in its entirety.

### BACKGROUND OF THE INVENTION

1. Field of the Invention

The present invention relates to an optical pickup device that records data on optical media, reproduces and removes data from optical media. More particularly, the present invention relates to an aberration compensation element with which aberration correction can be accomplished in an optical manner, an optical system comprising the same and an optical device to which the optical system is applied.

2. Description of the Related Art

As means for recording, reproducing or removing data, optical recording media are now predominantly used, exemplified by compact discs (CD) with a storage capacity of 650 MB, which requires a wavelength of 780 nm in combination with a numerical aperture of 0.5, and digital versatile discs (DVD) with a storage capacity of 4.7 GB, which requires a wavelength of 660 nm in combination with a numerical aperture of 0.65.

A number of attempts have recently been made to increase recording density. This is mainly achieved by using light sources of short wavelengths in combination with objective lenses having large numerical apertures. In detail, an improvement in recording density can be obtained by reducing the size of beam spots focused on optical recording media by using wavelengths shorter than 660 nm and increasing the numerical aperture of the objective lens over 0.65.

To date, a blue diode laser is employed to improve recording density, which has a wavelength as short as 405 nm and is used in combination with an objective lens having a numerical aperture as large as 0.85. However, because of the short wavelength of the blue diode laser, large spherical aberration is induced by variations in disc thickness. Also, chromatic aberration is caused by a fluctuation in light source wavelength according to a change in temperature as well as according to a change in the light emission power of the light source upon recording/regenerating. Of course, the aberration, whether spherical or chromatic, needs compensation.

Many technologies have been developed to compensate for such spherical aberration and chromatic aberration. For instance, an optical apparatus disclosed in Japanese Patent Laid-Open Publication No. 2004-111012 is shown in FIGS. 7 and 8.

As shown in FIG. 7, a phase compensation means 105′ comprises a liquid crystalline layer 105a′ sandwiched between a pair of glass substrates 105b′ with a diffractive plane 105c′ formed on at least one side.

FIG. 8 shows a pickup structure comprising the phase compensation means 105′.

Usually, the pickup, as shown, consists essentially of a blue wavelength-based Blu-ray(BD) optical system comprising a blue wavelength laser diode 101′, a collimate lens 102′, a polarizing beam splitter 103′, dichroic prisms 203 and 303′, a polarizing prism 104′, a phase compensation means 105′, a quarter wavelength plate 106′, an aperture selector 107′, an objective lens 108′, a detecting lens 110′, a light flux splitter 111′, and a photodetector 112′; a red wavelength-based DVD optical system comprising a hologram unit 201′, a collimate lens 202′, dichroic prisms 203′ and 303′, a polarizing prism 104′, a phase compensation means 105′, a quarter wavelength plate 106′, an aperture selector 107′, and an objective lens 108′; and an infrared wavelength-based CD optical system comprising a hologram unit 301′, a collimate lens 302′, a dichroic prism 303′, a polarizing prism 104′, a phase compensation means 105′, a quarter wavelength plate 106′, an aperture selector 107′, and an objective lens.

Usually, conventional phase compensation means has a planar form of a liquid crystalline layer and shows a limited change in refractive index with voltage application. To overcome the disadvantage, two objective lenses are joined to form one group.

### SUMMARY OF THE INVENTION

The present invention is to solve the problems encountered in prior arts and has an object of providing an aberration compensation element which is able to enlarge the refraction angle of light beams incident thereonto by employing a curved liquid crystalline layer as an aberration compensation means.

Another object of the present invention is to provide an optical system which can use single objective lenses by employing an aberration compensation element comprising a curved liquid crystalline layer.

A further object of the present invention is to provide an optical device in which the aberration compensation element mounted onto a base so that the production yield of the optical device is improved.

In accordance with a first aspect of the present invention, there is provided an aberration compensation element, including: a liquid crystalline layer, at least one side of which has a predetermined curvature; glass substrates laminated on both sides of the liquid crystalline layer; and transparent electrodes, interposed between the liquid crystalline layer and each glass substrate, for receiving an external voltage.

In one version of the first aspect, the glass substrates have a diffraction pattern formed on at least one external surface so as to compensate chromatic aberrations.

In another version of the first aspect, the liquid crystalline layer has a curvature meeting the following formula:
(h²+r²)/2h
wherein, r is the radius of the liquid crystalline layer, and h is the height of the liquid crystalline layer at the center position.

In a further version of the first aspect, the radius of the liquid crystalline layer ranges from 0.5 to 2.5 mm and the height is in the range of 5 to 100 μm.

In accordance with a second aspect of the present invention, there is provided an optical system, including: a three-wavelength hologram module including a three-wavelength light emitter/photodetector covering blue, red and infrared wavelengths; a collimate lens, positioned parallel to and in front of the three-wavelength hologram module; the aberration compensation element, positioned parallel to and in front of the collimate lens; an aperture selector, positioned parallel to and in front of the aberration compensation element; and an objective lens, positioned parallel to and in front of the aperture selector.

In accordance with a third aspect of the present invention, there is provided an optical system, including: a three-wavelength laser diode module including a three-wavelength light emitter covering blue, red and infrared wavelengths; a collimate lens, positioned parallel to and in front of the three-wavelength laser diode module; a prism, positioned parallel to and in front of the collimate lens; the aberration compensation element, positioned parallel to and in front of the prism; an aperture selector, positioned parallel to and in front of the aberration compensation element; an objective lens, positioned parallel to and in front of the aperture selector; a photodetector, positioned at a right angle with regard to the prism; and a condenser, positioned parallel to and between the prism and the photodetector.

In accordance with a fourth aspect of the present invention, there is provided an optical system, including: a blue wavelength laser diode; a first prism, positioned parallel to and in front of the blue wavelength laser diode; a first collimate lens, positioned parallel to and in front of the first prism; a first dichroic prism, positioned parallel to and in front of the first collimate lens; the aberration compensation element, positioned parallel to and in front of the dichroic prism; an aperture selector, positioned parallel to and in front of the aberration compensation element; an objective lens, positioned parallel to and in front of the aperture selector; a blue wavelength photodetector, positioned at a right angle with regard to the first prism; a two-wavelength photodetector, positioned at a right angle with regard to the dichroic prism; a second collimate lens, positioned parallel to and between the dichroic prism and the two-wavelength photodetector; a second prism, positioned parallel to and between the second collimate lens and the two-wavelength photodetector; and a two-wavelength diode covering red and infrared wavelengths, positioned parallel to the blue wavelength laser diode and at a right angle with regard to the second prism.

In accordance with a fifth aspect of the present invention, there is provided an optical device including the optical system, in which the aberration compensation element is mounted on a base.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross sectional view showing an aberration compensation element according to an embodiment of the present invention;

FIG. 2 is a schematic cross sectional view showing an aberration compensation element according to another embodiment of the present invention;

FIG. 3 is a schematic view showing an optical system having the aberration compensation element of FIG. 2 in accordance with an embodiment of the present invention;

FIG. 4 is a schematic view showing an optical system having the aberration compensation element of FIG. 2 in accordance with yet another embodiment of the present invention;

FIG. 5 is a schematic view showing an optical system having the aberration compensation element of FIG. 2 in accordance with a further embodiment of the present invention;

FIGS. 6A and 6B are plots in which spherical aberrations are plotted versus disc thickness before and after the compensation for aberration is completed by use of the aberration compensation element of the present invention, respectively;

FIG. 7 is a schematic cross sectional view showing a conventional phase compensation means; and

FIG. 8 is a schematic view showing an optical system comprising the phase compensation means of FIG. 7.

### DETAILED DESCRIPTION OF THE INVENTION

To describe an aberration compensation element, an optical system, and an optical device in detail, reference now should be made to the drawings, in which the same reference numerals are used throughout the different drawings to designate the same or similar components

With reference to FIG. 1, an aberration compensation element 10 comprising a pair of glass substrates 12 with a liquid crystalline layer sandwiched therebetween is shown in accordance with an embodiment of the present invention.

One side of the liquid crystalline layer 11 is a curved surface with a curvature satisfying the following formula:
(h²+r²)/2h

wherein, r is the radius of the liquid crystalline layer 11, and h is the height of the liquid crystalline layer 11 at the center position.

A larger height h of the liquid crystalline layer 11 brings about a larger change in refractive index into the optical medium so that light refracts at a larger angle, resulting in optical aberration compensation to a higher degree. Therefore, in the case of the use of a blue wavelength laser (wavelength 405 nm) in combination with a large NA (0.85) objective lens, the aberration compensation element 10 can easily compensate for the spherical aberration induced by the thickness variations of the optical disc.

However, as the height of the liquid crystalline layer 11 is larger, the voltage applied across the liquid crystalline layer 11 must be larger. Therefore, the height of the liquid crystalline layer 11 is preferably limited to within a range. In this embodiment according to the present invention, the height of the liquid crystalline layer 11 is set in the range of 5 to 100 μm. Accordingly, the radius of the liquid crystalline layer 11 is in the range from 0.5 to 2.5 mm.

Positioned between the liquid crystalline layer 11 and the glass substrates 12, transparent electrodes, not shown, are electrically connected to an external voltage.

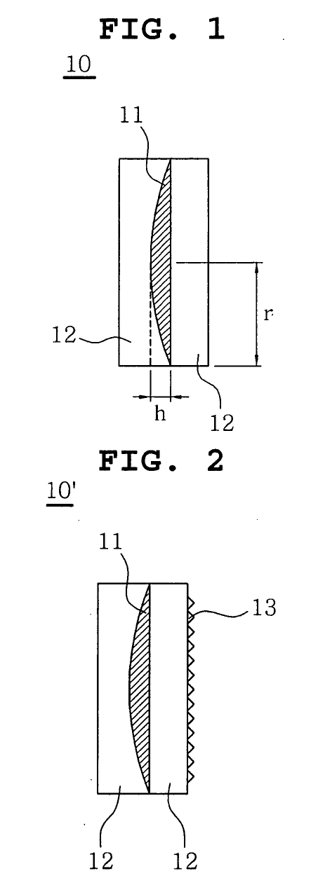

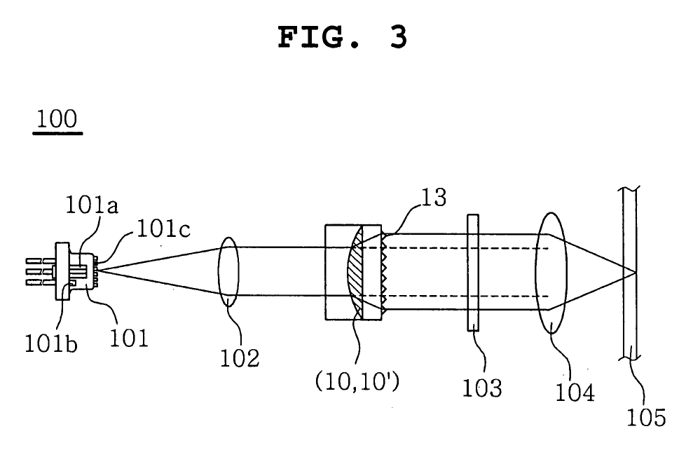

With reference to FIG. 2, an aberration compensation element 10′ is shown in accordance with another embodiment of the present invention, like that of FIG. 1. A difference is that the aberration compensation element 10′ comprises a liquid crystalline layer 11 intercalating a pair of glass substrates 12, with a diffraction pattern 13 formed on one external side of the glass substrates 12.

Likewise, transparent electrodes (not shown) are positioned between the liquid crystalline layer 11 and the glass substrates 12, with an electrical connection to an external voltage.

This structure enables the aberration compensation element 10′ to compensate for the spherical aberration induced by the variations in thickness of the optical medium as well as for the chromatic aberration caused by the wavelength fluctuation according to a change in the temperature of the light source and a change in the light emission power of the light source on recording/regenerating.

Referring to FIGS. 3 to 5, optical systems to which the aberration compensation element 10 or 10′ is applied are shown. In the optical systems, light sources are a blue laser (wavelength 405 nm) in conjunction with an NA=0.85 objective lens, a red laser (wavelength 660 nm) in conjunction with a NA=0.65 objective lens, and an infrared, laser (wavelength 780 nm) in conjunction with an NA=0.45 objective lens.

An optical system according to an embodiment of the present invention, as shown in FIG. 3, includes a three-wavelength hologram module 101 consisting of a three-wavelength light emitter 101a, e.g., blue wavelength laser diode, red wavelength laser diode and infrared wavelength laser diode, a three-wavelength photodetector 101b and a hologram 101c, a collimate lens 102, an aberration compensation element 103, an aperture selector 104, and an objective lens 105.

A blue, a red and an infrared wavelength beam projected from the three-wavelength hologram module 101 travel parallel to each other after the collimate lens 102, as indicated by real lines.

While passing through the aberration compensation element 10 or 10′, the parallel beams refract at a predetermined diffusion angle, which leads to the correction of spherical aberration. That is, the diffusion of the parallel beams at a predetermined angle compensates for the spherical aberration greatly induced by variations in thickness of optical media.

Since the diffusion, the beam reaches the diffraction pattern 13 formed on the external side of the aberration compensation element 10′ and undergoes diffraction. The diffraction serves to correct chromatic aberrations induced by the fluctuation in wavelength of the beam according to temperature changes and with light emission power changes upon recording/regenerating.

The aberration-corrected beams continue to travel through the aperture selector 103 and the objective lens 104 and is focused onto an optical spot on the optical medium 105 and function to read, write or remove information thereat.

When reflected from the optical medium 105, the beams take the parallel path represented by the dotted lines from the objective lens 104 through the aperture selector 104 to the aberration compensation element 10 or 10′, and by the real lines from the aberration compensation element 10 or 10′ through the collimate lens 102 to the photodetector 101b of the three-wavelength hologram module 101. In the photodetector 101b, aberration signals, information signals and servo signals are detected.

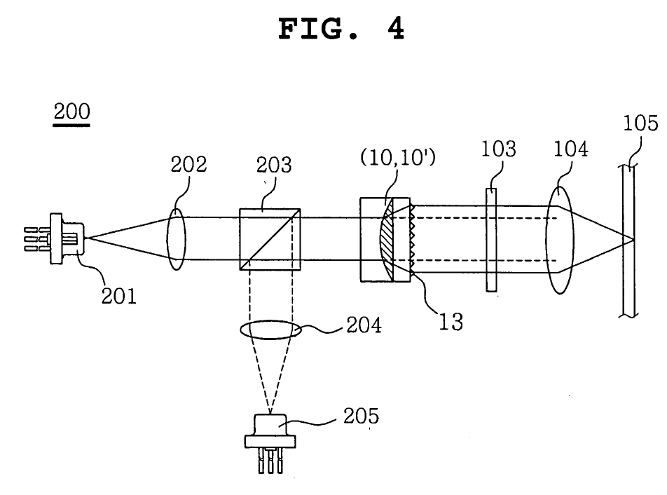

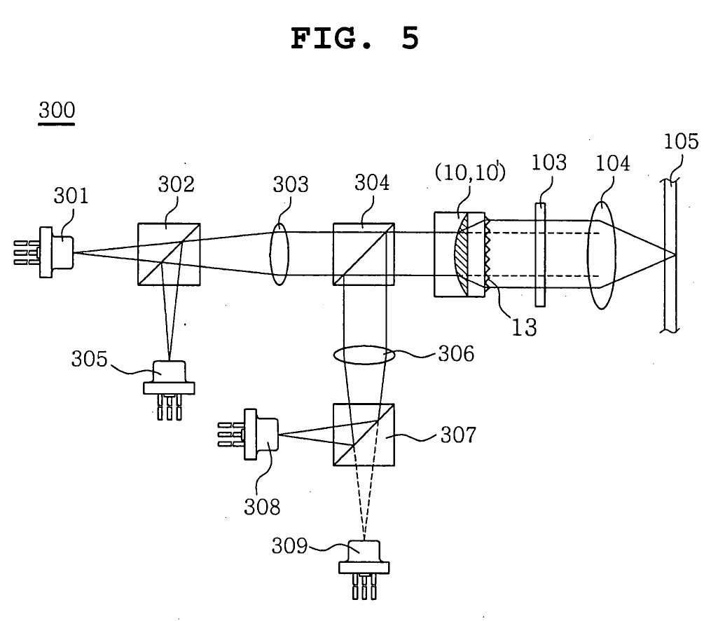

With reference to FIG. 4, an optical system is shown in accordance with another embodiment, which comprises a three-wavelength laser diode module 201, e.g., a blue, red and infrared wavelength laser diode module, a collimate lens 201, a prism 203, an aberration compensation element 10 or 10′, an aperture selector 103, an objective lens 104, a condenser 204, and a three-wavelength photodetector 205.

Blue, red and infrared wavelength beams projected from the three-wavelength laser diode module 201 pass through the collimate lens 102 from which they travel parallel to each other as indicated by real lines.

After taking the path through the prism 203 to the aberration compensation element 10 or 10′, the parallel beams refract at a predetermined diffusion angle in the aberration compensation element 10 or 10′, which leads to the correction of spherical aberration. That is, the diffusion of the parallel beams at a predetermined angle compensate for the spherical aberration greatly induced by variations in the thickness of optical media.

Following the diffusion, the beams reach the diffraction pattern 13 formed on the external side of the aberration compensation element 10′ and diffract thereat. The diffraction serves to correct the chromatic aberration induced by the fluctuation in the wavelength of the beams according to temperature changes and with light emission power changes upon recording/regenerating.

The aberration-corrected beams continue to travel through the aperture selector 103 and the objective lens 104 and are focused onto an optical spot on the optical medium 105 and functions to read, write or remove information thereat.

When reflected from the optical medium 105, the beams travel parallel to each other through the objective lens 104, the aperture selector 103, and the aberration compensation element 10 or 10′ and the collimate lens 102 while taking the path represented by dotted lines. When arriving at the prism 203, the beams are reflected at a right angle. These beams go through the condenser 204 to the three-wavelength photodetector 205 which functions to detect aberration signals, information signals, and servo signals from the beams reflected from the optical medium 105.

With reference to FIG. 5, an optical system according to another embodiment of the present invention is shown which comprises a blue wavelength laser diode 301, a first prism 302, a first collimate lens 303, a dichroic prism 304, an aberration compensation element 10 or 10′, an aperture selector 103, an objective lens 104, a blue wavelength photodetector 305, a two-wavelength (red/infrared wavelength) laser diode 308, a second collimate lens 306, a second prism 307, and a two-wavelength photodetector 309.

Blue beams from the blue wavelength laser diode 301 pass through the first prism 302 to the first collimate lens 303 from which they travel parallel to each other, as indicated by real lines.

After keeping the parallel path through the dichroic prism 304 to the aberration compensation element 10 or 10′, the beam refracts at a predetermined diffusion angle in the aberration compensation element 10 or 10′, which leads to the correction of spherical aberration. That is, the diffusion of the parallel beams at a predetermined angle compensate for spherical aberration induced by variations in thickness of optical media.

Following the diffusion, the beam reaches the diffraction pattern 13 formed on the external side of the aberration compensation element 10′ and diffracts thereat. The diffraction serves to correct the chromatic aberration induced by the fluctuation in wavelength of the beams according to temperature changes and to light emission energy changes upon recording/regenerating.

The aberration-corrected beams continue to travel through the aperture selector 103 and the objective lens 104 and is focused onto an optical spot on the optical medium 105 and function to read, write, or remove information thereat.

When reflected from the optical medium 105, the beams travel parallel to each other through the objective lens 104, the aperture selector 103, the aberration compensation element 10 or 10′, the dichroic prism 304 and the first collimate lens 303 while taking the path represented by dotted lines. When arriving at the first prism 302, the beams are reflected at a right angle onto the blue wavelength photodetector 305 which functions to detect aberration signals, information signals, and servo signals from the beams reflected from the optical medium 105.

Meanwhile, red/infrared wavelength beams from the two-wavelength laser diode 308 reflect at the second prism 307 as indicated by real lines and go through the second collimate lens 306 from which they keep a path parallel to the dichroic prism 304.

Thereafter, the parallel beams reflect again toward the optical medium 105 in the dichroic prism, and refract at a predetermined diffusion angle in the aberration compensation element 10 or 10′, which leads to the correction of spherical aberrations. That is, the diffusion of the parallel beam at a predetermined angle compensates for the spherical aberration induced by variations in thickness of optical media.

Following the diffusion, the beams reach the diffraction pattern 13 formed on the external side of the aberration compensation element 10′ and diffract thereat. The diffraction serves to correct the chromatic aberration induced by the fluctuation in wavelength of the beams according to temperature changes and to light emission energy changes upon recording/regenerating.

The aberration-corrected beams continue to travel through the aperture selector 103 and the objective lens 104 and are focused onto an optical spot on the optical medium 105, at which functions of reading, writing, or removing information are performed.

Also, when reflected from the optical medium 105, the beams travel parallel to each other through the objective lens 104, the aperture selector 103 and the aberration compensation element 10 or 10′, while taking the path represented by dotted lines. When arriving at the dichroic prism 304, the beams are reflected at a predetermined angle to the two-wavelength photodetector 309 through the second collimate lens 306 and the second prism 307. In the two-wavelength photodetector, aberration signals, information signals, and servo signals are detected from the beam reflected from the optical medium 105. Given in the following Table 1 are data on the corrected aberration which are obtained after the application of the aberration compensation elements 10 and 10′ shown in FIGS. 1 and 2 to the optical systems shown in FIGS. 3 to 5.

TABLE 1

| Thick. of Optical Medium | Corrected Aberration |
|---|---|
| (disc) [mm] | [λrms] |
| 0.075 | 0.035 |
| 0.083 | 0.022 |
| 0.092 | 0.018 |
| 0.100 | 0.033 |

As apparent from the table 1, the spherical aberration is kept to less than 0.04 λrms although the thickness of an optical medium varies in the range of as large as ±25 μm.

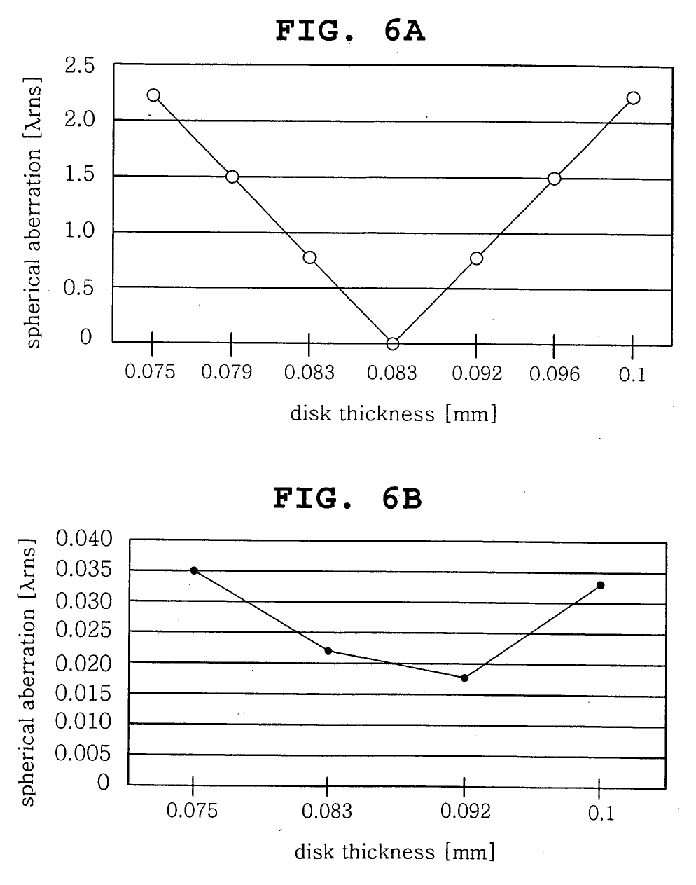

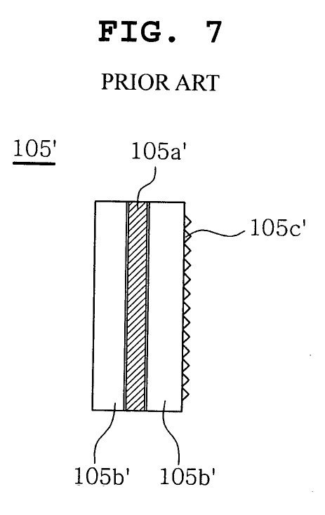

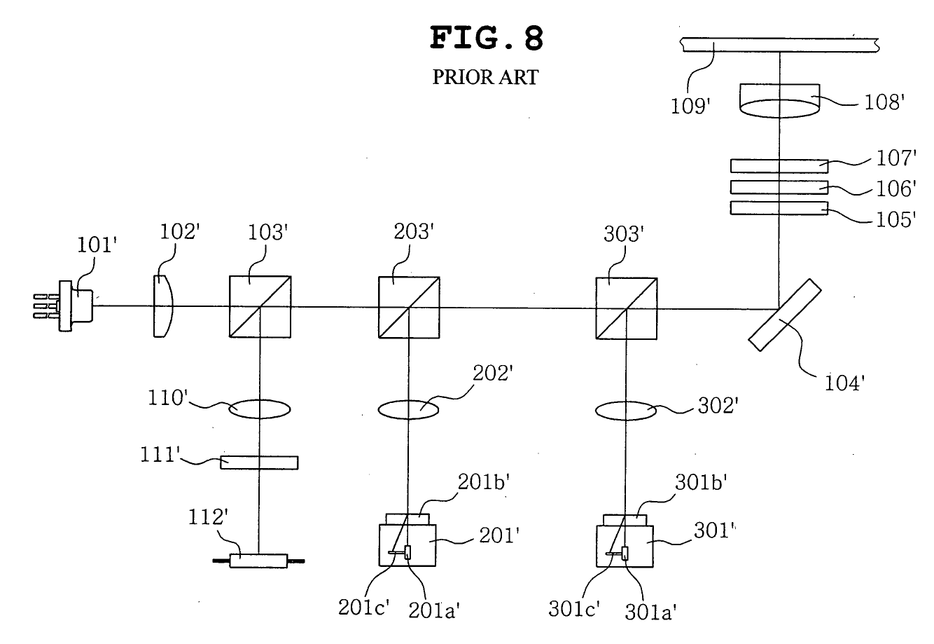

Data obtained after the aberration compensation element was used to correct the aberration is shown in FIG. 6B while data obtained without aberration correction is shown in FIG. 6A.

In the case that the aberration is not compensated, the spherical aberration is up to 2.2 λrms while the thickness of an optical medium changes from 0.075 to 0.1 mm, or vice versa, with a variation of ±25 μm, as shown in FIG. 6A.

After the compensation for aberration, the spherical aberration increases to as little as 0.035 λrms while an optical medium changes in thickness from 0.075 to 0.1 mm, or vice versa, with a variation of ±25 μm, as shown in FIG. 6B.

In accordance with the present invention, an optical device supplied with one of the optical systems described above, is provided in which, by virtue of its superior decenter tolerance due to the compensation for spherical aberration, the aberration compensation element of the present invention is mounted on a fixed base portion, unlike the objective lens driven by the control of an actuator.

As described hereinbefore, the aberration compensation element can compensate for the spherical aberration induced by the variation in thickness of an optical disc because it contains such a liquid crystalline layer as to change the refractive index with the applied voltage.

In addition, the liquid crystalline layer has a curved surface which has a predetermined curvature so as to change the refractive index to a large degree. Therefore, even in the case of the blue monowavelength laser, the spherical aberration induced by the variation in thickness of an optical disc can be readily corrected.

Furthermore, the aberration compensation element of the present invention makes it possible to use single objective lenses, instead of dual objective lenses, thereby increasing the efficiency of the optical system.

The diffraction pattern formed on one side of the aberration compensation element compensates for the chromatic aberration which is caused by the wavelength fluctuation due to changes in temperature as well as in beam energy upon recording/regenerating.

Showing a superior decenter tolerance due to the compensation for the spherical aberrations, the aberration compensation element can be mounted on a fixed base portion, unlike the objective lens moving under the control of an actuator.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An aberration compensation element, comprising:
a liquid crystalline layer, having a predetermined curvature on at least one side;
glass substrates laminated on both sides of the liquid crystalline layer; and
transparent electrodes, receiving an external voltage, interposed between the liquid crystalline layer and each glass substrate.

2. The aberration compensation element as set forth in claim 1, further comprising a diffraction pattern compensating for chromatic aberrations formed on at least one external surface of the glass substrates.

3. The aberration compensation element as set forth in claim 1, wherein the curvature is defined by the formula:
(h²+r²)/2h
wherein, r is the radius of the liquid crystalline layer curvature, and h is the height of the liquid crystalline layer at the center position.

4. The aberration compensation element as set forth in claim 3, wherein the radius ranges from 0.5 to 2.5 mm and the height ranges from 5 to 100 μm.

5. An optical system, comprising:
a three-wavelength hologram module having a three-wavelength light emitter/photodetector for emitting and detecting blue, red and infrared wavelengths;
a collimate lens, positioned parallel to and in front of the three-wavelength hologram module;
the aberration compensation element of claim 1, positioned parallel to and in front of the collimate lens;
an aperture selector, positioned parallel to and in front of the aberration compensation element; and
an objective lens, positioned parallel to and in front of the aperture selector.

6. An optical system, comprising:
a three-wavelength laser diode module having a three-wavelength light emitter emitting blue, red and infrared wavelengths;
a collimate lens, positioned parallel to and in front of the three-wavelength laser diode module;
a prism, positioned parallel to and in front of the collimate lens;
the aberration compensation element of claim 1, positioned parallel to and in front of the prism;
an aperture selector, positioned parallel to and in front of the aberration compensation element;
an objective lens, positioned parallel to and in front of the aperture selector;
a photodetector, positioned at a right angle with regard to the prism; and
a condenser, positioned parallel to and between the prism and the photodetector.

7. An optical system, comprising:
a blue wavelength laser diode;
a first prism, positioned parallel to and in front of the blue wavelength laser diode;
a first collimate lens, positioned parallel to and in front of the first prism;
a first dichroic prism, positioned parallel to and in front of the first collimate lens;
the aberration compensation element of claim 1, positioned parallel to and in front of the dichroic prism;
an aperture selector, positioned parallel to and in front of the aberration compensation element;
an objective lens, positioned parallel to and in front of the aperture selector;
a blue wavelength photodetector, positioned at a right angle with regard to the first prism;
a two-wavelength photodetector, positioned at a right angle with regard to the dichroic prism;
a second collimate lens, positioned parallel to and between the dichroic prism and the two-wavelength photodetector;
a second prism, positioned parallel to and in between the second collimate lens and the two-wavelength photodetector; and
a two-wavelength diode wherein the two-wavelengths are red and infrared wavelengths, positioned parallel to the blue wavelength laser diode and at a right angle with respect to the second prism.

8. The optical system of claim 5, wherein the aberration compensation element is mounted on a fixed base.

9. The optical system of claim 6, wherein the aberration compensation element is mounted on a fixed base.

10. The optical system of claim 7, wherein the aberration compensation element is mounted on a fixed base.
